(19) United States
(12) Patent Application Publication
(10) Pub. No.: US 2020/0250530 A1
(43) Pub. Date: Aug. 6, 2020

(54) DEEP MACHINE LEARNING MODELING OF NETWORKING DEVICE IDENTIFICATION

(71) Applicant: HEWLETT PACKARD ENTERPRISE DEVELOPMENT LP, Houston, TX (US)

(72) Inventor: MIN-YI SHEN, Santa Clara, CA (US)

(21) Appl. No.: 16/783,703

(22) Filed: Feb. 6, 2020

Related U.S. Application Data
(60) Provisional application No. 62/802,002, filed on Feb. 6, 2019.

(51) Int. Cl. G06N 3/08; G06N 3/04; H04L 29/06; H04L 12/24; H04L 29/12; H04L 29/08

(52) U.S. Cl. CPC G06N 3/08; G06N 3/0445; H04L 63/1433; H04L 61/6022; H04L 41/16; H04L 61/2015; H04L 67/02; H04L 63/20

(57) ABSTRACT

Systems and methods are provided to determine a network device type of one or more networking devices using a deep machine learning (ML) model. Upon determining the device type, the systems and methods may alter security settings in the network. The deep machine learning modeling approach can integrate heterogeneous information sources and improve the coverage and accuracy of the device identification.

### CROSS-REFERENCE TO RELATED APPLICATIONS

This application is a non-provisional patent application of U.S. Patent Application No. 62/802,002 filed Feb. 6, 2019 titled “METHOD OF DEEP NETWORKING DEVICE IDENTIFICATION,” which is herein incorporated by reference in its entirety for all purposes.

### BACKGROUND

Networking device identification is traditionally achieved using a rule-based system. For example, a media access control (MAC) address of a source network device may correlate to a MAC address in a rule stored with the system. This stored correlation will identify the device corresponding with the MAC address. In this rule-based system, providers are required to maintain a database of the hundreds of thousands of rules. When a new network device establishes a connection, the system must match the incoming networking signal available at the time, and a prediction of the type of device may be made and saved. However, this traditional identification process is cumbersome, manual, and inefficient, with several networking devices being labeled as “unknown” types of devices due to missing rules. A better solution is needed.

### BRIEF DESCRIPTION OF THE DRAWINGS

The present disclosure, in accordance with one or more various embodiments, is described in detail with reference to the following figures. The figures are provided for purposes of illustration only and merely depict typical or example embodiments.

FIG. 1 illustrates an extensible accelerator core architecture, in accordance with an embodiment of the application.

FIG. 2 illustrates a sample integration of compute tiles in a standalone accelerator, in accordance with an embodiment of the application.

FIG. 3 illustrates a sample integration of a single tile in application specific controller, in accordance with an embodiment of the application.

FIG. 4 illustrates a process of device identification, in accordance with an embodiment of the application.

FIG. 5 illustrates a sample machine learning model with input layer, one or more hidden layers, and output layer, in accordance with an embodiment of the application.

FIG. 6 is an example process for identifying a networking device, in accordance with an embodiment of the application.

FIG. 7 is an example computing component that may be used to implement various features of embodiments described in the present disclosure.

The figures are not exhaustive and do not limit the present disclosure to the precise form disclosed.

### DETAILED DESCRIPTION

Networking device identification may be useful when increasing security of a network. For example, network device identification may be used to perform one or more security operations. In another example, network device identification may be used when optimizing networking performance in a large wireless networking environment. However, not all networking devices may be identified using the same methods, because there is no standardized convention for identifying a networking device. Different types of networking devices require different security policies and these devices may exhibit different behavior when utilizing the network. In view of this, traditional systems utilize a rule-based architecture to link the networking data with a predefined type of networking device.

The traditional, rule-based approach may suffer from various shortcomings, including the coverage and signature generation. For example, in traditional systems it may not be uncommon to see a dynamic host configuration protocol (DHCP) pattern that varies by a few digits from the same type of networking device, due to minor changes in version or operation system (OS) build. The rule-based approach may rely on updates of the pattern database to ensure the coverage. This may correspond with several networking devices being classified as “unknown” by rule-based approach. The rule based approach may require several human hours to identify the device signatures and register them into the rule database.

The present disclosure describes systems and methods to determine a networking device type of one or more networking devices in a network. Upon determining the networking device type, the systems and methods may alter security settings in the network. The deep machine learning modeling approach can integrate heterogeneous information sources and improve the coverage and accuracy of the device identification. The deep machine learning approach may be able to identify the “unknown” devices, because it may not strictly rely on the predefined rules. In some examples, the system may determine device identification dynamically using machine learning. Moreover, the deep learning approach may be capable of combining arbitrary number of input features due to the flexibility of the machine learning architecture.

Systems and methods can additionally predict a device type that connects to a network (e.g., wireless Wi-Fi, etc.), for example, using sequences generated from initial connections to the network as input data. The input data may include, for example, a DHCP option sequence, a DHCP option 55 sequence, a MAC address string, an HTTP user agent string, or other string values as potential information that can be used to identify a networking device type. A set of inputs (e.g., sequences of real-valued input vectors, information associated with input nodes, converted digits from network packet data, etc.) associated with this input data may be provided to a machine learning model, including a long-short term memory (LSTM) recurrent neural network (RNN). The final states of the RNNs may be merged into a feature vector corresponding to the sequence encoding layers of the model. The decoding layer may connect the feature vector with, for example, a fully connected layer with dropout regularization. The layer connected to the loss layer may represent each device type with one-hot encoding.

These deep learning models can improve temporal behavior predictions for anomaly detection, security, maintenance, etc. to support emerging algorithms for unsupervised learning, e.g., sequence memory. In some examples, memristor based accelerators may be well suited for machine learning.

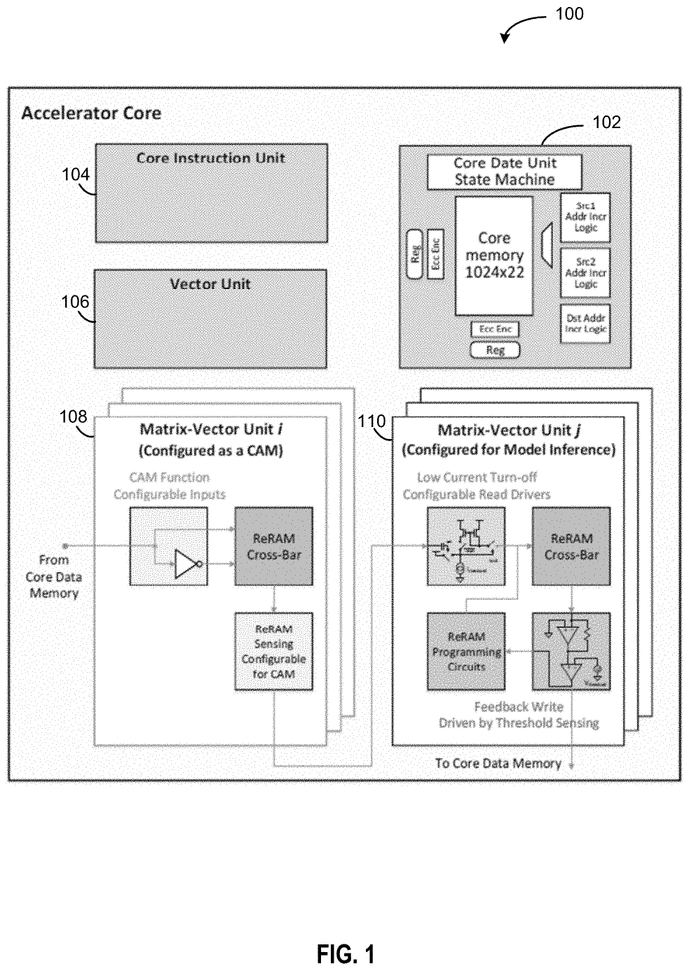

FIG. 1 illustrates an extensible accelerator core architecture, in accordance with an embodiment of the application. Accelerator core 100 may comprise core date unit state machine 102, core instruction unit 104, vector unit 106, first matrix-vector unit 108 configured as a content addressable memory (CAM), and second matrix-vector unit 110 configured for model interference. Accelerator core 100 may be designed to rapidly manipulate and alter memory to accelerate, for example, the processing of a machine learning (ML) model that receives input and determines a corresponding network device type based on the input. The parallel structure of accelerator core 100 may improve efficiency by processing large blocks of data in parallel.

Alternative architectures to accelerator core 100 may be implemented in other embodiments of the application to improve the temporal behavior predictions that support ML models. For example, a graphics processing unit (GPU) or tensor processing unit (TPU) may be implemented. These devices may be used in embedded systems, mobile phones, personal computers, workstations, and game consoles.

Core Data Unit (CDU) 102 may interface with Vector Unit and multiple Matrix-Vector Multiplication Units (MVMUs). On the field programmable gate array (FPGA), memristor MVMUs may be emulated by digital units that store model weights in a static random-access memory (SRAM).

First matrix-vector unit 108 may receive CAM function configurable units from core data memory. The CAM circuit may be configured to execute potential synapse selection in a sparse matrix using Matrix-Vector Multiplication Units (MVMUs). The match may be detected if the memristor crossbar column is at a low current, i.e., all input rows at logic 1 connect to memristors in high resistive state (HRS). Two cross-bar rows may be used for matching each data input: one row for non-inverted input driven to memristor cell set to the match value, the other row for inverted input driven to memristor cell set to inverted match value.

Second matrix-vector unit 110 may receive output from ReRAM sensing configurable for CAM at a low current turn-off configurable read driver. The low current turn-off configurable read driver may be implemented for connected synapse identification at a crossbar row driver level. Output from second matrix-vector unit may be provided to core data memory.

In some examples, feedback learning loops can be implemented in the analog domain rather than entirely in the digital domain. For example, when a convolution neural network (CNN) or other ML model is implemented, the input signal may pass through the analog converter, to the digital domain, and provide the digital output of the ML model. In some examples, the output may be provided to a Peripheral Component Interconnect (PCI) or other local computer bus.

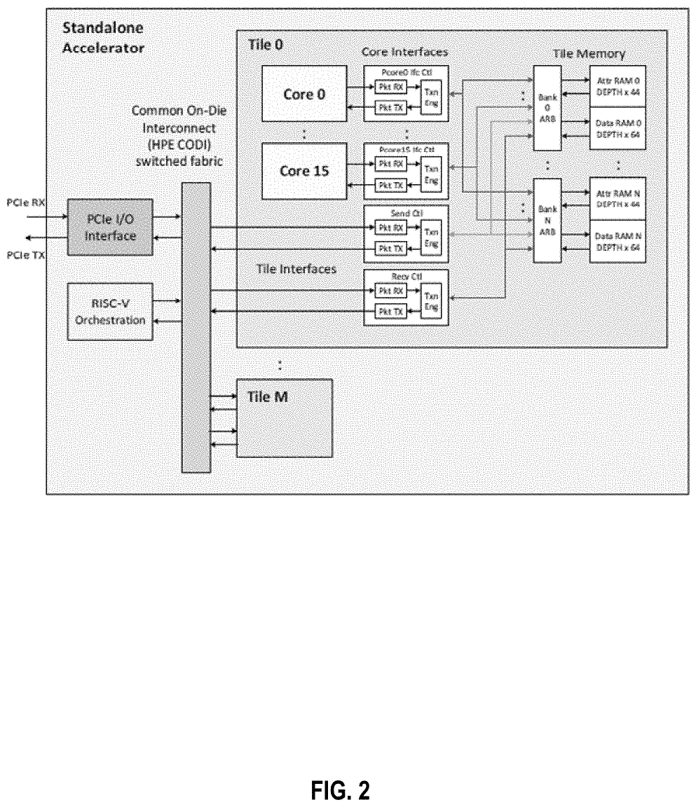

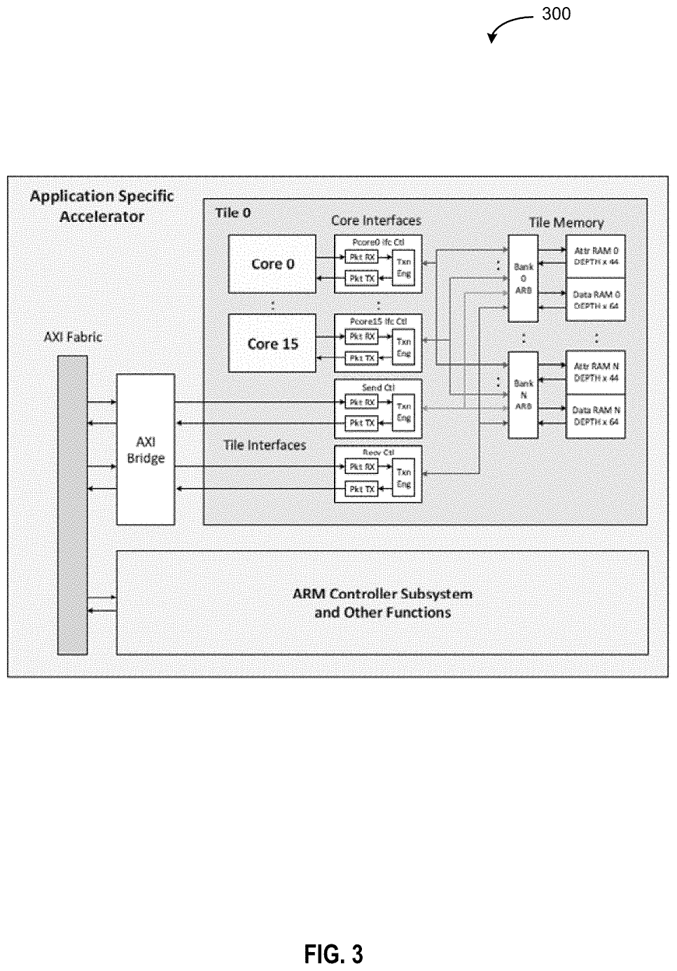

FIG. 2 illustrates a sample integration of compute tiles in a standalone accelerator and FIG. 3 illustrates a sample integration of a single tile in application specific controller. In illustration 300 of FIG. 3, the application-specific accelerator may use an Advanced eXtensible Interface (AXI) streaming interface bridge to connect directly to the controller application response measurement (ARM) subsystem. This may determine the internal processing transactions to be monitored.

Various cores may share tile memory. For example, in illustration 300, sixteen cores may share tile data memory, which may be divided into several banks to increase the bandwidth and reduce core access latency. Each bank may use a round robin arbitration to resolve bank conflicts among asynchronously operating cores.

In some examples, a Wi-Fi connected mobile device type and Operating System (OS) version may be inferred from network data packets using machine learning. This can enable internet of things (IoT) device visibility, classification, device specific management, monitoring, and anomaly detection. Since different mobile OS versions have known vulnerabilities, specific per-device firewall policies can also be applied.

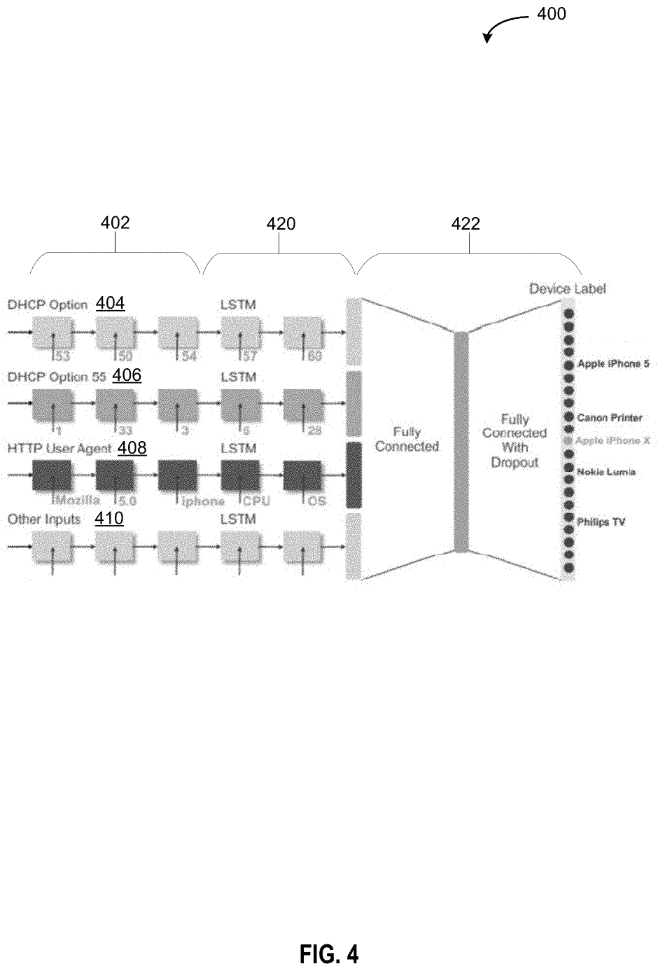

FIG. 4 illustrates a process of device identification, in accordance with an embodiment of the application. In process 400, input data 402 may comprise DHCP Option sequence 404, DHCP Option 55 sequence 406, HTTP user agent string 408, and MAC address Organizational Unique Identifier (OUI) values 410. Since input data 402 provided with process 400 originates from a network packet, any information that is included with standard network packets can be provided as input data 402. Additional values may be received as input data 402 without diverting from the scope of the disclosure.

Input data 402 are processed using various methods. For example, the DHCP Options (e.g., DHCP Option sequence 404, DHCP Option 55 sequence 406, etc.) may be obtained from the request packet of DHCP sequence and may be presented within the packet in a certain order specific to each device type. The request packet may be available when a device joins the network and attempts to obtain an IP address. The sequence may be processed by one-hot encoding or embedding layer before providing input data 402 to the ML model.

DHCP Option sequence 404 may correspond with tagged data items that provide information to a DHCP client. The options may be sent in a variable-length field in a DHCP message.

DHCP Option 55 sequence 406 may correspond with tagged data items that provide information to a DHCP client. The DHCP server may return the options to the DHCP client in a specific DHCP Discover packet. The options may be sent in a variable-length field in a DHCP message. In some examples, when DHCP Option 55 is turned off, more data may be provided from the DHCP server to the DHCP client in terms of additional data and options.

DHCP Option sequence 404 may be presented in some or all request packets as it configures the basic functionality like lease time, message time, etc. Among them, DHCP Option 55 sequence 406 may be useful as this data sequence may include a “parameter request list” in order to request additional parameters. Each device type tends to handle this request differently, so an identification and analysis of DHCP Option 55 sequence 406 may be beneficial in ultimately identifying the device type. Other options may be important as well, including for example, DHCP Option 60 sequence, etc.

HTTP user agent string 408 may correspond with the client software originating the request, using a user-agent header. In some examples, the user agent may identify itself, application type, operating system (OS), software vendor, or software revision, by submitting a characteristic identification string to an operating peer in the header field of a network packet.

MAC address string 410 may correspond with a layer-two hardware identification string that uniquely identifies each device on a network. The MAC address may be manufactured with the network card of the networking device.

Input data 402, including the example data provided herein, may be extracted from one or more network packets. Process 400 may include inference process 420 to apply the trained model to new data. In some examples, inference process 420 may employ Long-Short Term Memory (LSTM) models for behavioral feature extraction, followed by fully connected cross-feature layers for device type inference. Input data 402 may be encoded and passed as input to trained ML model 422 (e.g., CNN).

ML model 422 may comprise an artificial recurrent neural network (RNN) architecture used in deep learning or a Gated Recurrent Unit (GRU) model. In some examples, the GRU model weights may be re-quantization from 32-bit floating point to 8-bit integer precision (at 94.9% int8 accuracy vs. trained 95.1% float accuracy). As a sample illustration, ML model 422 may correspond with approximately 250K weights and may fit to nine cores in a single tile.

Other ML models may be implemented as ML model 422 other than a LSTM RNN or a CNN. For example, ML model 422 may comprise a neural network that measures the relationship between the dependent variable (e.g., device type) and independent variables (e.g., device identifier, input data 402, etc.) by using multiple layers of processing elements that ascertain non-linear relationships and interactions between the independent variables and the dependent variable.

In another example, ML model 422 may correspond with an unsupervised learning method, such as k-nearest neighbors, to classify inputs based on observed similarities among the multivariate distribution densities of independent variables in a manner that may correlate with identification of the networking device type.

In another example, ML model 422 may be embodied as/implemented using linear regression. The linear regression may model the relationship between the dependent variable (e.g., device type) and one or more independent variables (e.g., device identifier, input data 402, etc.). In some examples, the dependent variable may be transformed using a logarithm, fixed maximum value, or other transformation or adjustment.

In some examples, ML model 422 may be implemented at a secondary network device, including a cloud computing system. In some examples, inference process 420 may be executed on a DPE FPGA demonstrator, campus or branch network controllers at the edge, or other devices.

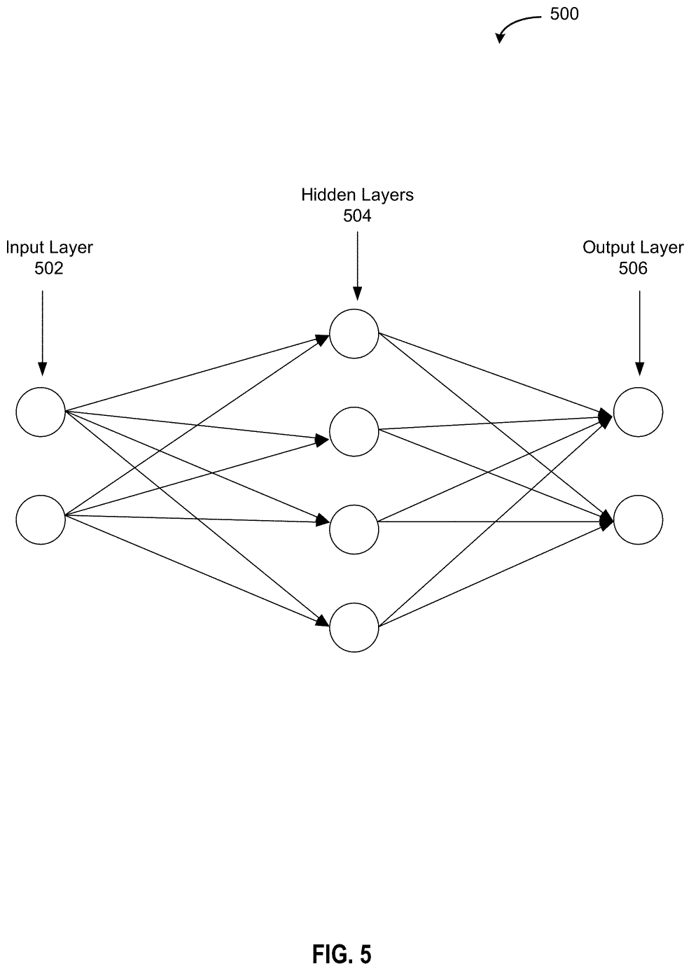

FIG. 5 illustrates a sample machine learning model with input layer 502, one or more hidden layers 504, and output layer 506. ML model 500 may correspond with one or more machine learning models, including a recurrent neural network (RNN), convolutional neural network (CNN), or other deep learning neural networks. ML model 500 may include an internal state (memory) to process variable length sequences of inputs. ML model 500 may consist of one or more hidden or loss layers 504 of processing elements between input layer 502 and output later 506. In some examples, hidden or loss layers 504 may comprise successive layers of processing elements that contain particular hierarchical patterns of connections with the previous layer.

ML model 500 may correspond with a recurrent neural network (RNN) where the connections between nodes form a directed graph along a temporal sequence. ML model 500 may exhibit temporal dynamic behavior. In some examples, ML model 500 may store states of the model, and the storage can be under direct control by the neural network. The storage can also be replaced by another network or graph, for example, when that incorporates time delays or has feedback loops. In some examples, the controlled states may correspond with a long short-term memory networks (LSTMs) and gated recurrent units.

ML model 500 may be implemented using various machine learning libraries, backend systems, and/or programming languages (e.g., Keras with TensorFlow).

Output layer 506 may correspond with a probability vector with associated confidence scores of each of the likely device types that are behind the network traffic. The probability vector may represent the possible outcomes of a discrete random variable (e.g., a particular device type), and the probability vector may identify the probability mass function of that random variable.

ML model 500 may be trained. For example, ML model 500 and the associated embedding layers may be trained using an iterative method for optimizing an objective function with differentiable or subdifferentiable smoothness properties. In some examples, the actual gradient calculated from the entire data set may be replaced with an estimate gradient that is calculated from a randomly selected subset of the data (e.g., to perform more efficient processing). In some examples, the training may be performed using stochastic gradient descent (SGD) with back propagation with the gradients from the loss layer.

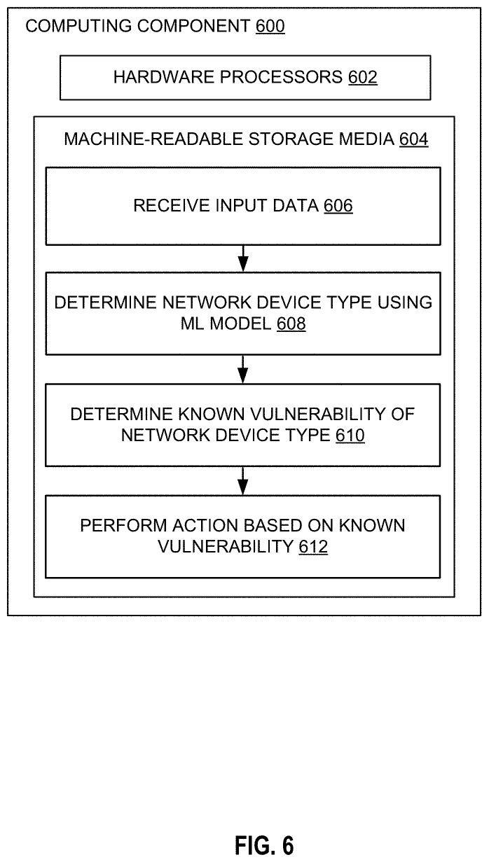

FIG. 6 is an example process for identifying a networking device, in accordance with an embodiment of the application. The computing component 600, hardware processors 602, and machine-readable storage medium 604 may correspond with accelerator core 100 and corresponding systems that are embedded in a computing component, including mobile phones, personal computers, workstations, and game consoles of FIG. 1.

At block 606, input data may be received. For example, a computer system may receive input data in a network data packet from a source network device.

At block 608, a network device type may be determined. For example, a computer system may determine a network device type for the input data and an associated confidence score. The network device type may be selected from a plurality of network device types. The determination of the network device type and the associated confidence score may comprise applying a set of input associated with the input data to a trained machine learning (ML) model.

At block 610, a known vulnerability may be determined. For example, a computer system may, upon determining that the network device type is a particular network device type, determining that the source network device is associated with a known vulnerability.

At block 612, an action may be performed based on the known vulnerability. For example, a computer system may increase firewall restrictions for an operating system corresponding with the known vulnerability. In another example, access to the system may be increased for an operating system corresponding with few known vulnerabilities or third party security enhancements that may increase security restrictions in another domain.

Other actions may be performed once the device type is identified and associated with a known vulnerability as well. For example, a system with outdated or end-of-life operating system (OS) may be firewalled, quarantined, required update/upgrade, or even physically removed from the network if evidence of indication of compromise (IOC) is discovered.

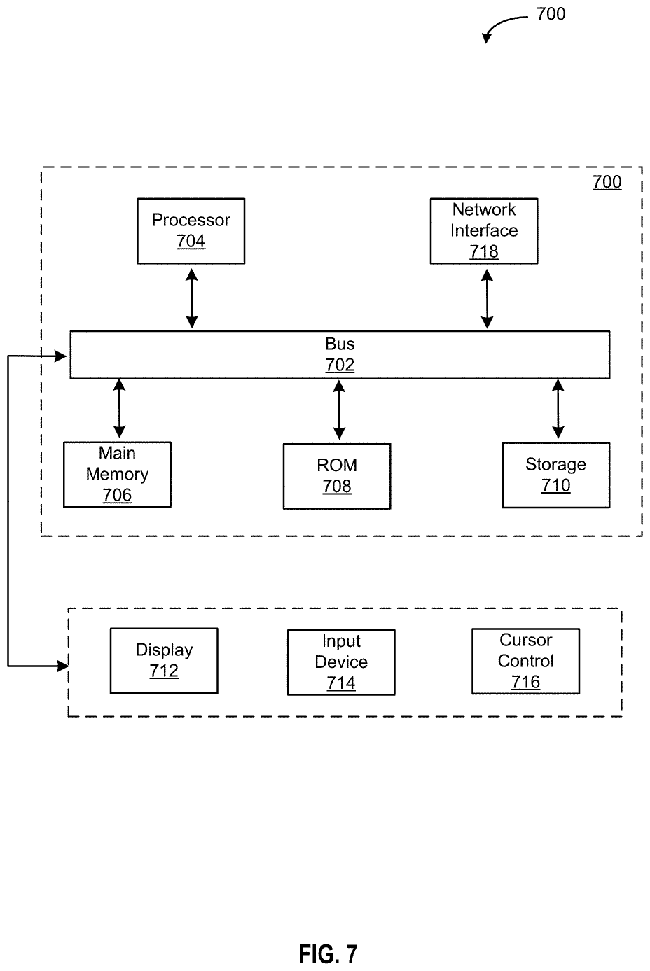

FIG. 7 depicts a block diagram of an example computer system 700 in which various of the embodiments described herein may be implemented. The computer system 700 includes a bus 702 or other communication mechanism for communicating information, one or more hardware processors 704 coupled with bus 702 for processing information. Hardware processor(s) 704 may be, for example, one or more general purpose microprocessors.

The computer system 700 also includes a main memory 706, such as a random access memory (RAM), cache and/or other dynamic storage devices, coupled to bus 702 for storing information and instructions to be executed by processor 704. Main memory 706 also may be used for storing temporary variables or other intermediate information during execution of instructions to be executed by processor 704. Such instructions, when stored in storage media accessible to processor 704, render computer system 700 into a special-purpose machine that is customized to perform the operations specified in the instructions.

The computer system 700 further includes a read only memory (ROM) 708 or other static storage device coupled to bus 702 for storing static information and instructions for processor 704. A storage device 710, such as a magnetic disk, optical disk, or USB thumb drive (Flash drive), etc., is provided and coupled to bus 702 for storing information and instructions.

The computer system 700 may be coupled via bus 702 to a display 712, such as a liquid crystal display (LCD) (or touch screen), for displaying information to a computer user. An input device 714, including alphanumeric and other keys, is coupled to bus 702 for communicating information and command selections to processor 704. Another type of user input device is cursor control 716, such as a mouse, a trackball, or cursor direction keys for communicating direction information and command selections to processor 704 and for controlling cursor movement on display 712. In some embodiments, the same direction information and command selections as cursor control may be implemented via receiving touches on a touch screen without a cursor.

The computing system 700 may include a user interface module to implement a GUI that may be stored in a mass storage device as executable software codes that are executed by the computing device(s). This and other modules may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables.

In general, the word “component,” “engine,” “system,” “database,” data store,” and the like, as used herein, can refer to logic embodied in hardware or firmware, or to a collection of software instructions, possibly having entry and exit points, written in a programming language, such as, for example, Java, C or C++. A software component may be compiled and linked into an executable program, installed in a dynamic link library, or may be written in an interpreted programming language such as, for example, BASIC, Perl, or Python. It will be appreciated that software components may be callable from other components or from themselves, and/or may be invoked in response to detected events or interrupts. Software components configured for execution on computing devices may be provided on a computer readable medium, such as a compact disc, digital video disc, flash drive, magnetic disc, or any other tangible medium, or as a digital download (and may be originally stored in a compressed or installable format that requires installation, decompression or decryption prior to execution). Such software code may be stored, partially or fully, on a memory device of the executing computing device, for execution by the computing device. Software instructions may be embedded in firmware, such as an EPROM. It will be further appreciated that hardware components may be comprised of connected logic units, such as gates and flip-flops, and/or may be comprised of programmable units, such as programmable gate arrays or processors.

The computer system 700 may implement the techniques described herein using customized hard-wired logic, one or more ASICs or FPGAs, firmware and/or program logic which in combination with the computer system causes or programs computer system 700 to be a special-purpose machine. According to one embodiment, the techniques herein are performed by computer system 700 in response to processor(s) 704 executing one or more sequences of one or more instructions contained in main memory 706. Such instructions may be read into main memory 706 from another storage medium, such as storage device 710. Execution of the sequences of instructions contained in main memory 706 causes processor(s) 704 to perform the process steps described herein. In alternative embodiments, hard-wired circuitry may be used in place of or in combination with software instructions.

The term “non-transitory media,” and similar terms, as used herein refers to any media that store data and/or instructions that cause a machine to operate in a specific fashion. Such non-transitory media may comprise non-volatile media and/or volatile media. Non-volatile media includes, for example, optical or magnetic disks, such as storage device 710. Volatile media includes dynamic memory, such as main memory 706. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, and networked versions of the same.

Non-transitory media is distinct from but may be used in conjunction with transmission media. Transmission media participates in transferring information between non-transitory media. For example, transmission media includes coaxial cables, copper wire and fiber optics, including the wires that comprise bus 702. Transmission media can also take the form of acoustic or light waves, such as those generated during radio-wave and infra-red data communications.

The computer system 700 also includes a network interface 718 coupled to bus 702. Network interface 718 provides a two-way data communication coupling to one or more network links that are connected to one or more local networks. For example, network interface 718 may be an integrated services digital network (ISDN) card, cable modem, satellite modem, or a modem to provide a data communication connection to a corresponding type of telephone line. As another example, network interface 718 may be a local area network (LAN) card to provide a data communication connection to a compatible LAN (or WAN component to communicated with a WAN). Wireless links may also be implemented. In any such implementation, network interface 718 sends and receives electrical, electromagnetic or optical signals that carry digital data streams representing various types of information.

A network link typically provides data communication through one or more networks to other data devices. For example, a network link may provide a connection through local network to a host computer or to data equipment operated by an Internet Service Provider (ISP). The ISP in turn provides data communication services through the world wide packet data communication network now commonly referred to as the “Internet.” Local network and Internet both use electrical, electromagnetic or optical signals that carry digital data streams. The signals through the various networks and the signals on network link and through network interface 718, which carry the digital data to and from computer system 700, are example forms of transmission media.

The computer system 700 can send messages and receive data, including program code, through the network(s), network link and network interface 718. In the Internet example, a server might transmit a requested code for an application program through the Internet, the ISP, the local network and the network interface 718.

The received code may be executed by processor 704 as it is received, and/or stored in storage device 710, or other non-volatile storage for later execution.

Each of the processes, methods, and algorithms described in the preceding sections may be embodied in, and fully or partially automated by, code components executed by one or more computer systems or computer processors comprising computer hardware. The one or more computer systems or computer processors may also operate to support performance of the relevant operations in a “cloud computing” environment or as a “software as a service” (SaaS). The processes and algorithms may be implemented partially or wholly in application-specific circuitry. The various features and processes described above may be used independently of one another, or may be combined in various ways. Different combinations and sub-combinations are intended to fall within the scope of this disclosure, and certain method or process blocks may be omitted in some implementations. The methods and processes described herein are also not limited to any particular sequence, and the blocks or states relating thereto can be performed in other sequences that are appropriate, or may be performed in parallel, or in some other manner. Blocks or states may be added to or removed from the disclosed example embodiments. The performance of certain of the operations or processes may be distributed among computer systems or computers processors, not only residing within a single machine, but deployed across a number of machines.

As used herein, a circuit might be implemented utilizing any form of hardware, software, or a combination thereof. For example, one or more processors, controllers, ASICs, PLAs, PALs, CPLDs, FPGAs, logical components, software routines or other mechanisms might be implemented to make up a circuit. In implementation, the various circuits described herein might be implemented as discrete circuits or the functions and features described can be shared in part or in total among one or more circuits. Even though various features or elements of functionality may be individually described or claimed as separate circuits, these features and functionality can be shared among one or more common circuits, and such description shall not require or imply that separate circuits are required to implement such features or functionality. Where a circuit is implemented in whole or in part using software, such software can be implemented to operate with a computing or processing system capable of carrying out the functionality described with respect thereto, such as computer system 700.

As used herein, the term “or” may be construed in either an inclusive or exclusive sense. Moreover, the description of resources, operations, or structures in the singular shall not be read to exclude the plural. Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps.

Terms and phrases used in this document, and variations thereof, unless otherwise expressly stated, should be construed as open ended as opposed to limiting. Adjectives such as “conventional,” “traditional,” “normal,” “standard,” “known,” and terms of similar meaning should not be construed as limiting the item described to a given time period or to an item available as of a given time, but instead should be read to encompass conventional, traditional, normal, or standard technologies that may be available or known now or at any time in the future. The presence of broadening words and phrases such as “one or more,” “at least,” “but not limited to” or other like phrases in some instances shall not be read to mean that the narrower case is intended or required in instances where such broadening phrases may be absent.

What is claimed is:

1. A computer-implemented method for determining network device identification, the method comprising:
receiving, by a computer system, input data in a network data packet from a source network device;
determining, by the computer system, a network device type for the input data and an associated confidence score, wherein the network device type is selected from a plurality of network device types, and wherein determining the network device type and the associated confidence score comprises applying a set of input associated with the input data to a trained machine learning (ML) model;
upon determining that the network device type is a particular network device type, determining that the source network device is associated with a known vulnerability; and
performing an action based on the known vulnerability.

2. The method of claim 1, wherein the trained ML model is a convolution neural network (CNN).

3. The method of claim 1, wherein the trained ML model is a long short-term memory (LSTM) model that comprises an artificial recurrent neural network (RNN) architecture used in deep learning or a Gated Recurrent Unit (GRU) model.

4. The method of claim 1, wherein the input data comprises DHCP option sequence, DHCP option 55 sequence, MAC address string, or HTTP user agent string.

5. The method of claim 1, wherein each layer connected to a loss layer of the trained ML model represents each network device type in the plurality of network device types.

6. The method of claim 1, wherein the trained ML model is implemented with an extensible accelerator core architecture.

7. A non-transitory machine-readable storage media storing instructions that, when executed by a processor, cause the processor to:
receive input data in a network data packet from a source network device;
determine a network device type for the input data and an associated confidence score, wherein the network device type is selected from a plurality of network device types, and wherein determining the network device type and the associated confidence score comprises applying a set of input associated with the input data to a trained machine learning (ML) model;
upon determining that the network device type is a particular network device type, determine that the source network device is associated with a known vulnerability; and
perform an action based on the known vulnerability.

8. The machine-readable storage media of claim 7, wherein the trained ML model is a convolution neural network (CNN).

9. The machine-readable storage media of claim 7, wherein the trained ML model is a long short-term memory (LSTM) model that comprises an artificial recurrent neural network (RNN) architecture used in deep learning or a Gated Recurrent Unit (GRU) model.

10. The machine-readable storage media of claim 7, wherein the input data comprises DHCP option sequence, DHCP option 55 sequence, MAC address string, or HTTP user agent string.

11. The machine-readable storage media of claim 7, wherein each layer connected to a loss layer of the trained ML model represents each network device type in the plurality of network device types.

12. The machine-readable storage media of claim 7, wherein the trained ML model is implemented with an extensible accelerator core architecture.

13. A computer system comprising:
a processor; and
a non-transitory computer readable media including instructions that, when executed by the processor, cause the processor to:
receive input data in a network data packet from a source network device;
determine a network device type for the input data and an associated confidence score, wherein the network device type is selected from a plurality of network device types, and wherein determining the network device type and the associated confidence score comprises applying a set of input associated with the input data to a trained machine learning (ML) model;
upon determining that the network device type is a particular network device type, determine that the source network device is associated with a known vulnerability; and
perform an action based on the known vulnerability.

14. The computer system of claim 13, wherein the trained ML model is a convolution neural network (CNN).

15. The computer system of claim 13, wherein the trained ML model is a long short-term memory (LSTM) model that comprises an artificial recurrent neural network (RNN) architecture used in deep learning or a Gated Recurrent Unit (GRU) model.

16. The computer system of claim 13, wherein the input data comprises DHCP option sequence, DHCP option 55 sequence, MAC address string, or HTTP user agent string.

17. The computer system of claim 13, wherein each layer connected to a loss layer of the trained ML model represents each network device type in the plurality of network device types.

18. The computer system of claim 13, wherein the trained ML model is implemented with an extensible accelerator core architecture.
